(19) United States
(12) Patent Application Publication
(10) Pub. No.: US 2021/0097867 A1
(43) Pub. Date: Apr. 1, 2021

(54) CONTROL DEVICE, METHOD, AND NON-TRANSITORY COMPUTER READABLE MEDIUM FOR CONTROLLING AN UNMANNED AERIAL VEHICLE

(71) Applicant: Rakuten, Inc., Tokyo (JP)

(72) Inventor: Toshiaki TAZUME, Tokyo (JP)

(73) Assignee: Rakuten, Inc, Tokyo (JP)

(21) Appl. No.: 17/036,704

(22) Filed: Sep. 29, 2020

(30) Foreign Application Priority Data
Sep. 30, 2019 (JP) 2019-180637

(51) Int. Cl. G08G 5/00; G05D 1/06; G05D 1/10; B64C 39/02

(52) U.S. Cl. CPC G08G 5/006; G08G 5/0069; G05D 1/0653; G05D 1/105; B64C 2201/042; B64C 2201/14; B64C 2201/128; B64C 2201/104; B64C 2201/044; B64C 39/024

(57) ABSTRACT

A control device, non-transitory computer readable medium, and method for controlling an unmanned aerial vehicle (UAV), which acquires an allowable noise level identified on the basis of at least one of a time when the UAV is flying, an altitude at which the UAV is flying, an area where the UAV is flying, and weather in an airspace in which the UAV is flying; and controls flight of the UAV on the basis of the allowable noise level.

### CROSS REFERENCE TO RELATED APPLICATION

This application claims priority from Japanese Patent Application No. 2019-180637 filed on Sep. 30, 2019, the disclosure of which is incorporated herein by reference in its entirety.

### FIELD

Aspects of the disclosure relate to a technical field of a system or the like that takes measures against noise generated by flight of an unmanned aerial vehicle (“UAV”) .

### BACKGROUND

Studies have been made on measures for reducing noise generated during flight of an aircraft capable of flying unmanned, e.g., UAVs. For example, Patent Literature 1 discloses a technology of selecting a flight route whereby noise of a helicopter at the time of landing can be reduced by utilizing noise data detected by a microphone installed in a periphery of a heliport.

Patent Literature 2 discloses a technology of assisting a flying object to determine a route for traveling by displaying a combination of: a noise level predicted at a predetermined point on a recommended route; and the recommended route.

Patent Document 3 discloses a technology of deriving a revised flight route whereby an aircraft can fly by utilizing distribution of noise generated in a case where the aircraft flies along a standard flight route.

However, there is room for improvement in the measures of selecting a flight route whereby noise can be reduced by utilizing noise data as disclosed in the above-mentioned documents , especially as related to UAVs.

Related thereto, aspects of the disclosure are directed to providing a control device, non-transitory computer readable medium, and method for more flexibly taking measures against the noise generated by the flight of aircraft capable of flying unmanned, and in particular, UAVs.

Patent Literature 1: Japanese Unexamined Patent Publication No. H11-268697

Patent Literature 2: Japanese Unexamined Patent Publication No. 2006-213219

Patent Literature 3: Japanese Unexamined Patent Publication No. 2014-24456.

### SUMMARY

According to an exemplary non-limiting aspect of the disclosure, there is provided a control device configured to control an unmanned aerial vehicle (UAV), the control device comprising: at least one memory configured to store computer program code; and at least one processor configured to access the at least one memory and operate according to the computer program code , the computer program code comprising: acquisition code configured to cause the at least one processor to acquire an allowable noise level identified on the basis of at least one of a time when the UAV is flying, an altitude at which the UAV is flying, an area where the UAV is flying, and weather in an airspace in which the UAV is flying; and control code configured to cause the at least one processor to control flight of the UAV on the basis of the allowable noise level.

According to a further exemplary non-limiting aspect of the disclosure, the control code may further be configured to cause the at least one processor to control the flight of the UAV in accordance with a comparison result between the allowable noise level and a level of noise generated by the flight of the UAV.

According to another exemplary non-limiting aspect of the disclosure, the UAV may be configured to transport an article, and the control code may further configured to cause the at least one processor to control the UAV such that an article transfer method is varied in accordance with the allowable noise level at a time of transferring the article.

According to a further exemplary non-limiting aspect of the disclosure, the control code may be further configured to cause the at least one processor to control the UAV to lower the article while making the UAV hover for the transferring of the article.

According to a further exemplary non-limiting aspect of the disclosure, the control code may be further configured to cause the at least one processor to control the UAV to land for the transferring of the article.

According to another exemplary non-limiting aspect of the disclosure, the UAV may include a propulsor configured to generate propulsion force, and the control code may be further configured to cause the at least one processor to perform drive control of the propulsor on the basis of the allowable noise level during the flight of the UAV.

According to a further exemplary non-limiting aspect of the disclosure, the UAV may further include a fixed wing, and the control code may further be configured to cause the at least one processor to perform the drive control such that the driving of the propulsor is stopped and the UAV glides with the fixed wing.

According to a further exemplary non-limiting aspect of the disclosure, the propulsor may include a plurality of rotary wings, and the control code may further be configured to cause the at least one processor to perform the drive control such that at least one of the plurality of rotary wings is stopped.

According to another exemplary non-limiting aspect of the disclosure, the UAV may include a propulsor configured to generate vertical propulsion force, and the control code may further be configured to cause the at least one processor to control a flight altitude of the UAV by controlling the propulsor on the basis of the allowable noise level during the flight of the UAV.

According to another exemplary non-limiting aspect of the disclosure, the UAV may include a rotary wing, an internal combustion engine, and a battery, and the control code may be further configured to cause the at least one processor to control the flight of the UAV by selecting, as a power source to drive the rotary wing, either one of power supplied by a driving of the internal combustion engine and power supplied from the battery, in a state where the driving of the internal combustion engine is stopped, in accordance with the allowable noise level during the flight of the UAV.

According to an exemplary non-limiting aspect of the disclosure, there is provided a control method performed by a control device configured to control an UAV, the control method including: acquiring an allowable noise level identified on the basis of at least one of a time when the UAV is flying, an altitude at which the UAV is flying, an area where the UAV is flying, and weather in an airspace in which the UAV is flying; and controlling flight of the UAV on the basis of the allowable noise level.

According to an exemplary non-limiting aspect of the disclosure, there is provided a non-transitory computer readable storage medium storing instructions that cause at least one processor, to: acquire an allowable noise level of an UAV, the allowable noise level identified on the basis of at least one of a time when the UAV is flying, an altitude at which the UAV is flying, an area where the UAV is flying, and weather in an airspace in which the UAV is flying; and control flight of the UAV on the basis of the allowable noise level.

### BRIEF DESCRIPTION OF THE DRAWINGS

FIG. 1 is a diagram illustrating a schematic configuration example of a flight system S according to embodiments.

FIG. 2 is a diagram illustrating a schematic configuration example of an UAV 1 according to embodiments.

FIG. 3A is a diagram illustrating a schematic configuration example of a control server CS according to embodiments.

FIG. 3B is a diagram illustrating an example of functional blocks in a control unit 23 according to embodiments.

FIGS. 4A to 4D are diagrams illustrating level correlation table examples according to embodiments.

FIGS. 5A and 5B are conceptual diagrams illustrating areas AR1 to AR3 according to embodiments.

FIG. 6 is a sequence diagram illustrating an exemplary operation of the flight system S in a case where drive control of rotors of the UAV 1 in flight is performed on the basis of an allowable noise level, according to embodiments.

FIG. 7 is a sequence diagram illustrating an exemplary operation of the flight system S in a case of performing selection control of an article transfer method during flight on the basis of an allowable noise level, according to embodiments.

### DETAILED DESCRIPTION

Hereinafter, aspects of the disclosure will be described with reference to the drawings.

### 1. Outline of Configuration and Operation of Flight System S

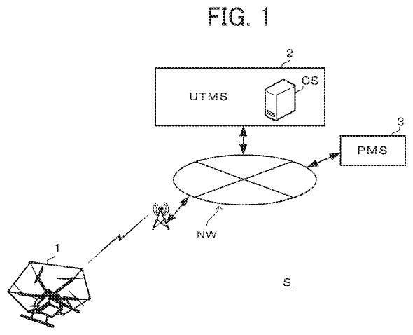

First, a description is provided with reference to FIG. 1 with regard to a configuration and an outline of operation of a flight system S by which an aircraft capable of flying unmanned, e.g. an UAV is made to fly for a predetermined purpose. Examples of the predetermined purpose can include transportation, surveying, image capturing, inspection, monitoring, and the like. FIG. 1 is a diagram illustrating a schematic configuration example of the flight system S. As illustrated in FIG. 1, the flight system S includes: an unmanned aerial vehicle (hereinafter, referred to as an “UAV (Unmanned Aerial Vehicle)”) 1 that flies in the atmosphere (air), a traffic management system (hereinafter, referred to as an “UTMS (UAV Traffic Management System)”) 2, and a port management system (hereinafter, referred to as a “PMS (Port Management System)”) 3. The UAV 1, the UTMS 2, and the PMS 3 can communicate with one another via a communication network NW. The communication network NW includes, for example, the Internet, a mobile communication network, a radio base station thereof, and the like. Incidentally, although one UAV 1 is shown in the example of FIG. 1, there may be a plurality of UAVs 1. The UTMS 2 and the PMS 3 may be configured as one management system.

The UAV 1 can fly in accordance with remote control from the ground by an operator or can fly autonomously. The UAV 1 is an example of an aircraft capable of flying unmanned. The UAV 1 may also be referred to as a drone or a multi-copter. The UAV 1 is managed by a GCS (Ground Control Station). For example, the GCS is installed as an application in a control terminal that can be connected to the communication network NW. In this case, the operator is, for example, a person who operates the control terminal to remotely control the UAV 1. Alternatively, the GCS may be configured by a server or the like. In this case, the operator is, for example, a manager in the GCS or a controller provided in the server.

The UTMS 2 includes one or more servers and the like including a control server CS. The control server CS is an example of a control device. The UTMS 2 manages traffic and flight of the UAV 1. The traffic management of an UAV 1 includes management of a traffic plan of the UAV 1; and management of a flight status of the UAV 1, and control of the UAV 1. The traffic plan of the UAV 1 is a flight plan including, for example, a flight route (scheduled route) from a departure point (flight start point) to a destination point (or a waypoint) for the UAV 1. The flight route is represented by, for example, latitude and longitude on the route, and may include flight altitude. The management and control of the flight status of the UAV 1 is performed on the basis of aircraft information of the UAV 1. The aircraft information of the UAV 1 includes at least position information of the UAV 1. The position information of the UAV 1 indicates the current position of the UAV 1. The current position of the UAV 1 is a flight position of the UAV 1 in flight. The aircraft information of the UAV 1 may include speed information of the UAV 1. The speed information of the UAV 1 indicates a flight speed of the UAV 1.

Moreover, the control of an UAV 1 is performed on the basis of an allowable noise level. The allowable noise level means, for example, an allowable level (degree) of noise generated by flight of the UAV 1 (that is, due to the UAV 1 flying). The allowable noise level is identified on the basis of at least one parameter out of a time zone when the aircraft is flying, an altitude at which the aircraft is flying, an area where the aircraft is flying, and weather in an airspace in which the aircraft is flying. The time zone includes time (or date and time) when the aircraft is currently flying. The allowable noise level may be varied by at least one of the time zone, the altitude, the area, and the weather in the airspace. For example, in a case of making the UAV 1 fly at night or fly above an area including a residential area, it is assumed that the noise generated by the flight of the UAV 1 causes an issue. Such an issue caused by the noise may also depend on the altitude at which the UAV 1 flies or the weather in the airspace where the UAV 1 flies. Accordingly, even when the UAV 1 flies at night or flies above the area including the residential area, the UAV 1 can be controlled so as to fly while suppressing the generated noise to an allowable level or less by using: the allowable noise level identified on the basis of the above-described parameter(s); and a level (hereinafter, referred to as an “aircraft noise level”) of the noise generated by the flight of the UAV 1. Incidentally, the control of the UAV 1 may include air traffic control such as giving information and instructions to the UAV 1 in accordance with the flight status of the UAV 1.

The PMS 3 includes one or a plurality of servers and the like. The PMS 4 manages a takeoff and landing facility (hereinafter, referred to as “port”), for example, that is installed at the destination point (or the waypoint) for the UAV 1. The port is managed on the basis of port position information, port reservation information, and the like. Here, the port position information indicates an installation position of the port. The port reservation information includes: an aircraft ID of the UAV 1 that has reserved the port; information on scheduled arrival time; and the like. The aircraft ID of the UAV 1 is identification information to identify the UAV 1. Incidentally, there may be a case where the UAV 1 lands at a point (hereinafter referred to as “temporary landing point”) other than a prepared point like the port. Examples of such cases include: a case where the UAV 1 can hardly keep normal flight due to a sudden change (deterioration) of the weather in the airspace where the UAV 1 flies; a case where the UAV 1 delivers relief articles at the time of disaster; and the like.

### 2. Outline of Configuration and Function of UAV 1

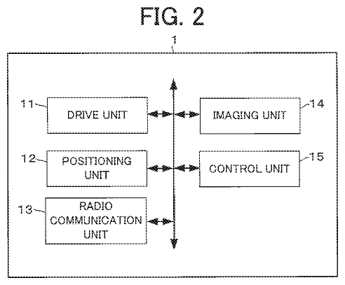

Next, the outline of the configuration and function of the UAV 1 will be described with reference to FIG. 2. FIG. 2 is a diagram illustrating a schematic configuration example of the UAV 1. As illustrated in FIG. 2, the UAV 1 includes a drive unit 11, a positioning unit 12, a radio communication unit 13, an imaging unit 14, a control unit 15, and the like. Incidentally, although not illustrated, the UAV 1 includes one or a plurality of rotors (propellers), various sensors, an article holding mechanism for holding the article to be transported, a battery that supplies power to each of the units of the UAV 1, and the like. The rotors are horizontal rotary wings and are an example of a propulsor configured to generate vertical propulsion force. There may be a case where the UAV 1 includes fixed wings together with the rotors (for example, a case where an UAV is a drone of a vertical takeoff and landing (VTOL) type). Moreover, the UAV 1 may include an internal combustion engine that drives a generator with motivity generated by burning fuel such as gasoline. In this case, it is possible to utilize: the power supplied from the battery; and power supplied from the generator by driving the internal combustion engine. The article transported by the UAV 1 is held by the article holding (loading) mechanism. Various sensors used for flight control of the UAV 1 include a barometric sensor (atmospheric pressure sensor), a three-axis acceleration sensor, a geomagnetic sensor, a weather sensor, and the like. The weather sensor is used for monitoring the weather. Detection information detected by the various sensors is output to the control unit 15.

The drive unit 11 includes a motor, a rotating shaft, and the like. The drive unit 11 rotates the rotors with the motor, the rotating shaft, and the like that are driven in accordance with a control signal output from the control unit 15. To drive the motor (in other words, to drive the rotors), either the power supplied from the battery or the power supplied by driving the internal combustion engine is utilized. The positioning unit 12 includes a radio wave receiver, an altitude sensor, and the like. For example, the positioning unit 12 receives, by the radio wave receiver, a radio wave sent from a satellite of a GNSS (Global Navigation Satellite System) and detects a current position (latitude and longitude) in a horizontal direction of the UAV 1 on the basis of the radio wave. Incidentally, the current position (horizontal position) in the horizontal direction of the UAV 1 may be corrected on the basis of an image captured by the imaging unit 14 or a radio wave sent from the radio base station. Further, the positioning unit 12 may detect the current position (altitude) in a vertical direction of the UAV 1 with the altitude sensor. The position information indicating the current position detected by the positioning unit 12 is output to the control unit 15.

The radio communication unit 13 controls communication performed via the communication network NW. The imaging unit 14 includes a camera and the like. The imaging unit 14 continuously captures images of a real space within a range included in an angle of view of the camera. Image data captured by the imaging unit 14 is output to the control unit 15. The control unit 15 includes a CPU (Central Processing Unit) which is a processor, a ROM (Read Only Memory), a RAM (Random Access Memory), a non-volatile memory, and the like. The control unit 15 executes various kinds of control for the UAV 1 in accordance with a control program (program code group) stored in, for example, the ROM or the non-volatile memory. The various kinds of control include takeoff control, flight control, landing control and article transfer control. Incidentally, during the flight of the UAV 1, the control unit 15 periodically or randomly transmits, to the UTMS 2 via the radio communication unit 13, the aircraft information of the UAV 1 together with the aircraft ID of the UAV 1.

In the flight control and the landing control, the position information acquired from the positioning unit 12, the image data acquired from the imaging unit 14, the detection information acquired from the various sensors, position information of points (the destination point, the waypoint, or the temporary landing point), and the like are used to perform: drive control of the rotors (including rotary speed control of the rotors); and control of a position, a posture, and a travel direction of the UAV 1. In such flight control, for example, flight plan information (indicating the flight route of the UAV 1, for example) acquired from the UTMS 2 may also be used. Incidentally, the autonomous flight of the UAV 1 is not limited to the autonomous flight performed under the flight control of the control unit 15 provided in the UAV 1, and the autonomous flight of the UAV 1 also includes, for example, autonomous flight performed by autonomous control as the entire the flight system S.

The drive control of the rotors is also performed in accordance with a control command which is based on the allowable noise level and provided from, for example, the UTMS 2 or a GCS. For example, the flight altitude of the UAV 1 is changed by the rotors in accordance with the control command based on the allowable noise level (in other words, in accordance with the allowable noise level). Moreover, some of the plurality of rotors may be stopped in accordance with the control command based on the allowable noise level. Moreover, in a case where the UAV 1 includes the fixed wings together with the rotors, driving of the rotors may be stopped in accordance with the control command based on the allowable noise level, and in this case, the UAV 1 performs gliding flight with the fixed wings (That is, the UAV 1 glides with the fixed wings). Moreover, in a case where the UAV 1 includes the internal combustion engine, either one of the power supplied by driving the internal combustion engine and the power supplied from the battery in a state where the driving of the internal combustion engine is stopped may be selected as the power to drive the rotors in accordance with the control command based on the allowable noise level.

In the article transfer control, for example, the article held by the article holding mechanism is transferred from the UAV 1 to a person or an UGV (Unmanned Ground Vehicle) at the destination point or the temporary landing point. Moreover, in a case where the article is handed over (passed) and transported by a plurality of UAVs 1, the article held by the article holding mechanism is transferred from one UAV 1 to another UAV 1 at the waypoint (handover point). The article transfer control is also performed in accordance with the control command which is based on the allowable noise level and provided from, for example, the UTMS 2 or the GCS. For example, one of a plurality of the article transfer methods is selected in accordance with the control command based on the allowable noise level. Examples of the article transfer method can include: (i) a method of lowering (bringing down) the article by using, for example, a reel, a winch, or the like while making the UAV 1 hover for transferring the article (the article transfer); and (ii) making the UAV 1 land (e.g., land on the ground) for transferring the article. According to the (i) article transfer method, when the article reaches the ground, or when the article reaches a height of several meters from the ground, the article transfer is performed by releasing the article. On the other hand, according to the (ii) article transfer method, the article transfer is performed by releasing (separating) the article after the UAV 1 landed. Incidentally, the article may be released by automatically (that is, in accordance with the control signal from the control unit 15) opening a hook that suspends the article or by manually (that is, by a person) opening the hook that suspends the article.

### 3. Outline of Configuration and Function of Control Server CS

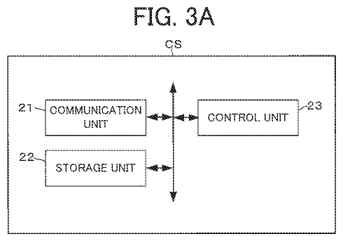

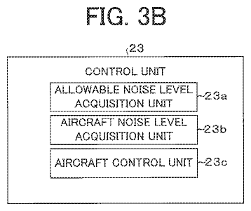

Next, an outline of a configuration and functions of the control server CS will be described with reference to FIGS. 3A and 3B. FIG. 3A is a diagram illustrating a schematic configuration example of the control server CS. As illustrated in FIG. 3A, the control server CS includes a communication unit 21, a storage unit 22, a control unit 23, and the like. The communication unit 21 controls communication performed via the communication network NW. The storage unit 22 includes, for example, a hard disk drive, and the like. The storage unit 22 stores the aircraft ID of the UAV 1, the aircraft noise level of the UAV 1, and the aircraft information of the UAV 1 in a correlated manner.

The control unit 23 includes one or more CPUs which are one or more processors, a ROM, a RAM, a non-volatile memory, and the like. The ROM or the non-volatile memory is configured to store a program (program code). The CPU is configured to access the program code and operate as instructed by the program code. The program code includes: acquisition code configured to cause at least one of the one or more processors to acquire the allowable noise level identified on the basis of the at least one the parameter, and control code configured to cause at least one of the one or more processors to control flight of the UAV 1 on the basis of the allowable noise level. FIG. 3B is a diagram illustrating an example of functional blocks in the control unit 23. As illustrated in FIG. 3B, the control unit 23 functions as an allowable noise level acquisition unit (an allowable noise level identification unit) 23a, an aircraft noise level acquisition unit 23b, an aircraft control unit 23c and the like, in accordance with the program code stored in, for example, the ROM or the non-volatile memory.

The allowable noise level acquisition unit 23a acquires the allowable noise level (information indicating the allowable noise level) identified on the basis of at least one parameter (variable) out of the time zone when the aircraft is flying, the altitude at which the aircraft is flying, the area where the aircraft is flying, and the weather in airspace in which the aircraft is flying. Here, at least one parameter out of the time zone, the altitude, the area, and the weather in the airspace relative to the UAV 1 flying is set in accordance with, for example, a request from a client (e.g., business operator) who makes a flight request for the purpose of transportation, surveying, image capturing, inspection, monitoring, or the like.

For example, an area where the UAV 1 currently flies for the purpose of article transportation is set as the parameter (parameter of the area). This parameter is represented by the position information indicating a horizontal position of the UAV 1, for example. Preferably, for the horizontal position, the width of movement in the horizontal direction may be taken into consideration. Alternatively, in addition to the area where the UAV 1 currently flies for the purpose of the article transportation, the time zone (e.g., 9:55-10:05) including the time (e.g., 10:00) at which the UAV 1 is flying is set as the parameter (parameter of the time zone). Alternatively, in addition to the area where the UAV 1 currently flies for the purpose of the article transportation (or the area and the time zone), the altitude (e.g., 110 m) where the UAV 1 currently flies is set as the parameter (parameter of the altitude). Preferably, for the altitude (vertical position), the width of movement in the vertical direction may be taken into consideration. Alternatively, in addition to the area where the UAV 1 currently flies for the purpose of the article transportation (or at least one of the area, the time zone, and the altitude), the weather (e.g., rainy weather) in the airspace where the UAV 1 currently flies (the airspace within the area) is set as the parameter (parameter of the weather). Here, the weather means a state of the atmosphere and includes not only, for example, sunny, rainy, snowy, and lightning weather conditions but also high humidity, strong wind, a wind direction, and the like. The weather may be acquired also from the weather forecast or the barometric sensor of the UAV 1. Incidentally, there is a case where the area where the UAV 1 currently flies is not be set as the parameter depending on a purpose of a client who makes a flight request. In this case, for example, only at least one parameter out of the time zone and the altitude is set.

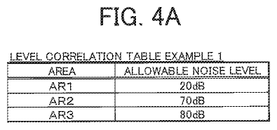

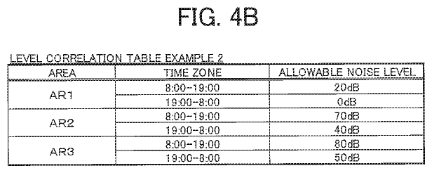

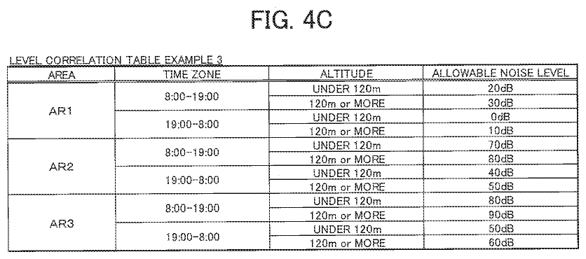

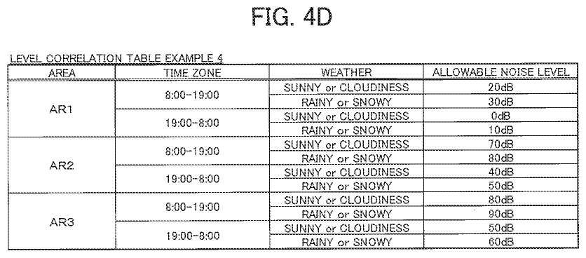

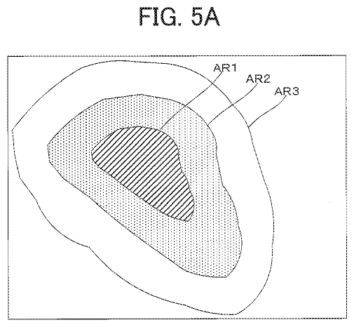

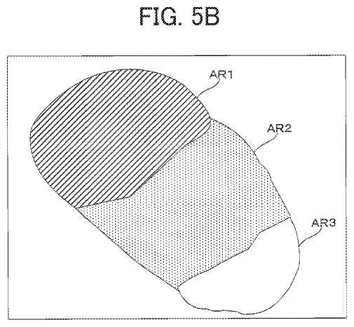

Then, the allowable noise level acquisition unit 23a identifies, for example, from a level correlation table, the allowable noise level corresponding to the parameter on the basis of the set parameter. Here, the level correlation table is prepared in advance and stored in the storage unit 22, for example. FIGS. 4A to 4D are diagrams illustrating level correlation table examples. In the examples of FIGS. 4A to 4D, each allowable noise level is represented by dB, but the representing method of the allowable noise level is not particularly limited. For example, the allowable noise level may be represented by two values such as high (H) and low (L). Moreover, in the example of FIGS. 4A to 4D, three sectioned areas AR1 to AR3 are exemplified for convenience of the description, but the number of sectioned areas may be two, or four or more. FIGS. 5A and 5B are conceptual diagrams illustrating the areas AR1 to AR3. In the example of FIG. 5A, the area AR1 is included in the area AR2, and the area AR2 is included in the area AR3. In the example of FIG. 5B, the area AR1 is adjacent to the area AR2, and the area AR2 is adjacent to the area AR3. Thus, the areas are sectioned in accordance with allowable noise levels. Incidentally, for example, in a case where an administrator of the flight system S makes the UAV 1 fly only in a limited region such as an isolated island, it is not necessary to provide sectioned areas and correlate the areas to respective allowable noise levels, and each allowable noise level is to be correlated to the time zone, the altitude, and the kind of weather, or a combination thereof. Moreover, preferably, the allowable noise levels illustrated in FIGS. 4A and 4B are indicated as, for example, allowable noise levels in the vicinity of the ground (for example, at a height of 1 meter from the ground).

In the level correlation table example 1 illustrated in FIG. 4A, the allowable noise levels are registered in a manner correlated to the respective three areas AR1 to AR3. Each of the areas AR1 to AR3 illustrated in FIG. 4A may be represented by: position information (latitude and longitude) of a center and a radius of each area; a plurality of pieces of position information on a boundary or inside the boundary of each area; or a name of administrative district of each area (such as Shibuya Ward, Shinjuku Ward, or Okutama City), for example. In the example of FIG. 4A, the area AR1 is an area having many houses, and therefore, the allowable noise level is lower than the other areas AR2 and AR3 (that is, noise is hardly allowable). For example, in a case where the set parameter (parameter of the area) indicates the area AR1, the allowable noise level “20 dB” correlated to the area AR1 is identified from the level correlation table example 1 illustrated in FIG. 4A. That is, “20 dB” is identified as the allowable noise level of the area set as the parameter.

In the level correlation table example 2 illustrated in FIG. 4B, the allowable noise levels are registered in a manner respectively correlated to combinations of the three areas AR1 to AR3 and two time zones. For example, in a case where set parameters (parameters of the area and the time zone) represent the area AR1 and the time zone “8:00-19:00”, the allowable noise level “20 dB” correlated to the area AR1 and the time zone “8:00-19:00” is identified from the level correlation table example 2 illustrated in FIG. 4B. That is, “20 dB” is identified as the allowable noise level of the area and the time zone set as the parameters. In the example of FIG. 4B, the two sectioned time zones are exemplified, but the number of sectioned time zones may be three or more.

In the level correlation table example 3 illustrated in FIG. 4C, the allowable noise levels are registered in a manner respectively correlated to combinations of the three areas AR1 to AR3, the two time zones, and two altitudes. For example, in a case where set parameters (parameters of the area, the time zone, and the altitude) represent the area AR1, the time zone “8:00-19:00”, and the altitude “less than 120 m” respectively, the allowable noise level “20 dB” correlated to the area AR1, the time zone “8:00-19:00”, and the altitude “less than 120 m” is identified from the level correlation table example 3 illustrated in FIG. 4C. That is, “20 dB” is identified as the allowable noise level of the area, the time zone, and the altitude set as the parameters. In the example of FIG. 4C, the sectioned two altitudes are exemplified, but the number of sectioned altitudes may be three or more.

On the other hand, in the level correlation table example 4 illustrated in FIG. 4D, the allowable noise levels are registered in a manner respectively correlated to combinations of the three areas AR1 to AR3, the two time zones, and two kinds of weather. For example, in a case where set parameters (parameters of the area, the time zone, and the weather) represent the area AR1, the time zone “8:00-19:00”, and “rainy” weather respectively, the allowable noise level “30 dB” correlated to the area AR1, the time zone “8:00-19:00”, and the “rainy” weather is identified from the level correlation table example 4 illustrated in FIG. 4D. That is, “30 dB” is identified as the allowable noise level of the area, the time zone, and the weather set as the parameters. In the example of FIG. 4D, the two sectioned kinds of weather are exemplified, but the number of sectioned kinds of weather may be three or more .

As another example, the allowable noise level acquisition unit 23a may acquire the allowable noise level by performing calculation using a predetermined parameter. In this case, the above-described level correlation tables may not be necessarily used. For example, the allowable noise level acquisition unit 23a calculates the allowable noise level by multiplying the predetermined parameter by a coefficient corresponding to a category of the parameter. For example, the allowable noise level is calculated as follows: [coefficient k corresponding to parameter]×[reference allowable level (e.g., 20 dB)]. Here, for example, a coefficient k corresponding to Shibuya Ward is set to “1”, and a coefficient k corresponding to Okutama City is set to “4”. Alternatively, a coefficient k corresponding to Shibuya-ku and “8:00-19:00” is set to “1”, and a coefficient k corresponding to Shibuya-ku and “19:00-8:00” is set to “0”.

The aircraft noise level acquisition unit 23b acquires the aircraft noise level of the UAV 1. The aircraft noise level is a maximum level or an average level of noise generated by flight of the UAV 1, and varied by the flight speed of the UAV 1 or weight of the article loaded on the UAV 1. For example, the faster the flight speed of the UAV 1 is, or the heavier the weight of the loaded article is, the more increased the rotary speed of the rotor is. Consequently, the aircraft noise level becomes higher. The noise generated by the flight of the UAV 1 may be measured when the UAV 1 takes off (e.g., measured with the article is loaded thereon) or may be estimated by performing interpolation or the like on the basis of results obtained from preliminary measurements (that, is, results measured in advance) under a plurality of measurement conditions. As the measurement conditions, for example, a flight speed, the weight of the loaded article, or the like is set. The noise generated by flight of the UAV 1 may be measured or estimated by the UAV 1 or by the UTMS 2 that manages the flight status of the UAV 1. Alternatively, the noise may be measured or estimated by the PMS 3 that manages the port where the UAV 1 takes off. Thus, the aircraft noise level identified from the measured or estimated noise is acquired by the aircraft noise level acquisition unit 23b.

The aircraft control unit 23c controls the UAV 1 in flight on the basis of the allowable noise level (that is, the allowable noise level corresponding to the above-described parameter(s) relative to the UAV 1 in flight) acquired by the allowable noise level acquisition unit 23a. Such control is performed by, for example, transmitting, to the UAV 1 or the GCS that manages the UAV 1, the control command based on the allowable noise level. For example, the aircraft control unit 23c performs drive control of rotors of the UAV 1 in flight or selection control of the article transfer method in accordance with a comparison result between the allowable noise level acquired by the allowable noise level acquisition unit 23a and the aircraft noise level of the UAV 1 acquired by the aircraft noise level acquisition unit 23b. According to this configuration, the UAV 1 in flight can be controlled such that the aircraft noise level of the UAV 1 does not exceed the allowable noise level.

For example, in the drive control of the rotors, when the aircraft noise level of the UAV 1 is likely to exceed the allowable noise level, the aircraft control unit 23c stops some of the plurality of rotors such that the aircraft noise level of the UAV 1 does not exceed the allowable noise level (that is, such that the aircraft noise level of the UAV 1 becomes the allowable noise level or less). This configuration allows the UAV 1 to fly with an appropriate flight method according to the allowable noise level. In the case where the UAV 1 includes the fixed wings together with the rotors, when the aircraft noise level of the UAV 1 is likely to exceed the allowable noise level, the aircraft control unit 23c may stop driving the rotors to perform gliding flight with the fixed wings such that the aircraft noise level of the UAV 1 does not exceed the allowable noise level (that is, such that the aircraft noise level of the UAV 1 becomes the allowable noise level or less).

In the drive control of the rotors, the aircraft control unit 23c may change the flight altitude of the UAV 1 by using the rotors of the UAV 1 on the basis of the allowable noise level (that is, the allowable noise level corresponding to at least the parameter of the altitude). This configuration allows the UAV 1 to fly at an appropriate altitude according to the allowable noise level. For example, in the case where the aircraft noise level of the UAV 1 exceeds the allowable noise level, the aircraft control unit 23c gains the altitude to an altitude where the aircraft noise level of the UAV 1 does not exceed the allowable noise level. Relative noise can be reduced by gaining the flight altitude. In a case where the UAV 1 includes the above-described internal combustion engine, the aircraft control unit 23c may select, as power to drive the rotors, either one of the power supplied by driving the internal combustion engine and the power supplied from the battery in a state where driving of the internal combustion engine is stopped, in accordance with the allowable noise level. For example, in a case where the allowable noise level is relatively low, the power can be supplied more quietly by selecting the power supplied from the battery in the state where the driving of the internal combustion engine is stopped. According to this configuration, the aircraft noise level of the UAV 1 can be controlled so as not to exceed the allowable noise level. Accordingly, the power can be supplied to the UAV 1 with an appropriate supply method according to the allowable noise level.

In the selection control of the article transfer method, the aircraft control unit 23c controls the UAV 1 such that the article transfer method is varied in accordance with the allowable noise level (that is, the allowable noise level corresponding to at least the parameter of the altitude) at the time of transferring the article held by the article holding mechanism. According to this configuration, the article can be transferred with an appropriate transfer method according to the allowable noise level. For example, in a case where the aircraft noise level of the UAV 1 does not exceed the allowable noise level but exceeds at least the allowable noise level corresponding to an altitude near the ground, the aircraft control unit 23c lowers the article while making the UAV 1 hover for the article transfer. According to this configuration, the noise generated by landing of the UAV 1 for the article transfer can be suppressed. On the other hand, when the aircraft noise level of the UAV 1 does not exceed the allowable noise level and does not exceed the allowable noise level corresponding to the altitude near the ground, the aircraft control unit 23c makes the UAV 1 land for the article transfer. According to this configuration, landing of the UAV 1 can be allowed for the article transfer.

The UAV 1 in flight may also be controlled without comparing the allowable noise level with the aircraft noise level. For example, a fixed reference level (threshold) may be preset irrespective of the aircraft noise level, and the drive control of the rotors or the selection control of the article transfer method may be performed in accordance with whether or not the allowable noise level is lower than the reference level. According to this configuration, a load required to acquire the aircraft noise level of the UAV 1 can be cut down. For example, in the drive control of the rotors, in a case where the allowable noise level is lower than the reference level, some of the plurality of rotors are stopped, the rotors are stopped to perform gliding flight with the fixed wings, or the flight altitude of the UAV 1 is gained. Moreover, in the selection control of the article transfer method, in a case where the allowable noise level is lower than the reference level, the article may be lowered while making the UAV 1 hover for the article transfer.

### 4. Operation of Flight System S

Next, operation of the flight system S will be described with reference to Example 1 and Example 2, which are separately described below. In the operation(s) described below, assume that the aircraft noise level of the UAV 1 is managed by the control server CS.

### Example Embodiment 1

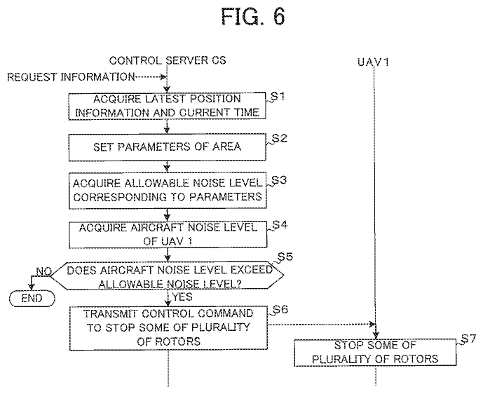

First, Example 1 of the operation of the flight system S will be described with reference to FIG. 6. FIG. 6 is a sequence diagram illustrating exemplary operation of the flight system S in a case where the drive control of rotors of the UAV 1 in flight is performed on the basis of the allowable noise level.

In FIG. 6, when request information is received from a terminal of a requester who makes, for example, a flight request for the purpose of the article transportation, the control server CS acquires, on the basis of the request information: latest position information (indicating a horizontal position, for example) received from the UAV 1 in flight; and current time (step S1). Next, the control server CS sets the above-described parameters (for example, parameters of the time zone, the altitude, and the area relative to the UAV 1 in flight) on the basis of the position information and the current time acquired in step S1 (step S2).

Next, the control server CS identifies and acquires, by the allowable noise level acquisition unit 23a, the allowable noise level corresponding to the parameters set in step S2 (step S3). Next, the control server CS acquires, by the aircraft noise level acquisition unit 23b, the aircraft noise level of the UAV 1 (step S4).

Next, the control server CS compares the allowable noise level acquired in step S3 with the aircraft noise level acquired in step S4, and determines whether or not the aircraft noise level exceeds the allowable noise level (step S5). In a case of determining that the aircraft noise level exceeds the allowable noise level (step S5: YES), the control server CS transmits, to the UAV 1, the control command to stop some of the plurality of rotors (step S6). The control command may also be transmitted to the UAV 1 via the GCS. Then, when the control command is received from the control server CS, the UAV 1 stops some of the plurality of rotors (for example, stops four rotors out of eight rotors) in accordance with the control command (step S7). On the other hand, in a case of determining that the aircraft noise level does not exceed the allowable noise level (step S5: NO), the control server CS ends the processing without transmitting the control command.

### Example Embodiment 2

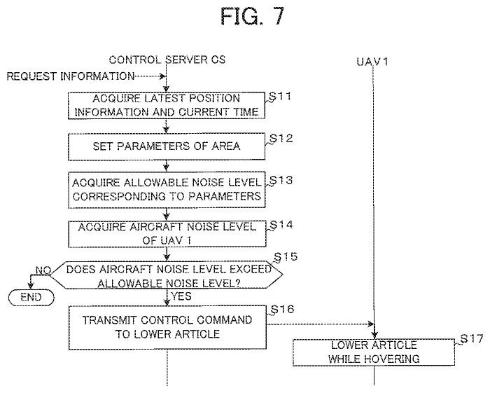

Next, Example 2 of the operation of the flight system S will be described with reference to FIG. 7. FIG. 7 is a sequence diagram illustrating exemplary operation of the flight system S in a case of performing the selection control of the article transfer method during flight on the basis of the allowable noise level.

In FIG. 7, when request information is received from a terminal of a requester who makes, for example, a flight request for the purpose of the article transportation, the control server CS acquires, on the basis of the request information: latest position information (indicating a horizontal position and an altitude, for example) received from the UAV 1 in flight; and current time (that is, the time when the article is transferred) (step S11). Steps S12 to S15 are similar to steps S2 to S5 illustrated in FIG. 6. In a case of determining that the aircraft noise level exceeds the allowable noise level (step S15: YES), the control server CS transmits, to the UAV 1, the control command to lower the article (step S16). The control command may also be transmitted to the UAV 1 via the GCS. Then, when the control command is received from the control server CS, the UAV 1 brings down the article while hovering in accordance with the control command (step S17). Consequently, when the article reaches the ground or reaches a height of several meters from the ground, the article is released. On the other hand, in a case of determining that the aircraft noise level does not exceed the allowable noise level (step S15: NO), the control server CS ends the processing without transmitting the control command. In this case, the article is released after the UAV 1 has landed.

As described above, according to the embodiments, the allowable noise level identified on the basis of at least one parameter out of the time when the UAV 1 is flying, the altitude at which the UAV 1 is flying, the area where the UAV 1 is flying, and the weather in the airspace in which the UAV 1 is flying. And then the UAV 1 in flight is controlled on the basis of the allowable noise level. Therefore, it is possible to more flexibly take measures against noise generated by the flight of the UAV 1.

Incidentally, the measures against the noise may also be taken by reducing noise or by determining a flight route so as to reduce influence of the noise, but taking only such measures may not be enough. In particular, it can be assumed that the UAV 1 capable of unmanned delivery of the article has the allowable noise level lower than that of a manned aircraft in an area near a take-off/landing area. According to the present embodiments, the measures against noise can be flexibly taken by lowering the aircraft noise level by controlling the UAV 1 in accordance with the time, the flight position, and the like of the UAV 1 currently flying.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof

For example, in the above-described embodiments, the control server CS acquires the allowable noise level and controls the UAV 1 in flight on the basis of the allowable noise level. However, instead of this configuration, the allowable noise level may be acquired by providing the UAV 1 or the GCS with an acquisition unit that acquires the allowable noise level, and the UAV 1 in flight may be controlled on the basis of the allowable noise level.

In the above-described embodiments, the allowable noise level may be used to control the UAV 1 in flight. However, even in the case where the UAV 1 in flight is controlled without using the allowable noise level (not via information like the allowable noise level), measures against the noise can be more flexibly taken. Namely, even in a case where the control unit (the control unit 15 or the control unit 23) that controls the UAV 1 which performs the article transportation is adapted to control the UAV 1 such that the article transfer method is varied on the basis of the time of transferring the article or a horizontal position of the UAV 1 in flight, the issue of the present application can be solved and the measures against the noise can be more flexibly taken. For example, in a case where the time when the article is transferred is within a predetermined time zone (e.g., night time) or in a case where the horizontal position of the UAV 1 in flight is within a predetermined area (e.g., area including a residential area), the control lowers the article while making the UAV 1 hover for the article transfer. Otherwise, the control unit makes the UAV 1 land for the article transfer.

Even in a case where the control unit (the control unit 15 or the control unit 23), which controls the UAV 1 including rotors to generate propulsion force, performs the drive control of the rotors on the basis of at least one parameter out of the time when the UAV 1 is flying, the horizontal position and/or the altitude at which the UAV 1 is flying, the area where the UAV 1 is flying, and the weather in airspace in which the UAV 1 is flying, measures against the noise can be more flexibly taken. For example, in a case where the parameter satisfies a predetermined condition, the control unit stops some of the plurality of rotors, and stops driving the rotors to perform gliding flight with the fixed wings or gains the flight altitude of the UAV 1. Here, examples of the predetermined condition include a condition that the time is included within a predetermined time zone, a condition that the horizontal position of the UAV 1 flying is inside a predetermined area, a condition that the altitude is a predetermined altitude or less, and a condition that the weather in the airspace is a predetermined kind of weather.

In the above-described embodiments, the descriptions are provided by exemplifying the UAV as an aircraft capable of flying unmanned, but the embodiments are also applicable to a manned aircraft capable of flying without a pilot (pilot) inside the aircraft. A person other than the pilot (for example, a passenger) may board this manned aircraft. In the above-described embodiments, the descriptions are provided by exemplifying the rotor as a propulsor to generate the vertical propulsion force, but a propulsor using jet injection may also be applied.

What is claimed is:

1. A control device configured to control an unmanned aerial vehicle (UAV) , the control device comprising:
at least one memory configured to store computer program code; and
at least one processor configured to access the at least one memory and operate according to the computer program code , the computer program code comprising:
acquisition code configured to cause the at least one processor to acquire an allowable noise level identified on the basis of at least one of a time when the UAV is flying, an altitude at which the UAV is flying, an area where the UAV is flying, and weather in an airspace in which the UAV is flying; and
control code configured to cause the at least one processor to control flight of the UAV on the basis of the allowable noise level.

2. The control device according to claim 1, wherein the control code is further configured to cause the at least one processor to control the flight of the UAV in accordance with a comparison result between the allowable noise level and a level of noise generated by the flight of the UAV.

3. The control device according to claim 1, wherein
the UAV is configured to transport an article, and
the control code is further configured to cause the at least one processor to control the UAV such that an article transfer method is varied in accordance with the allowable noise level at a time of transferring the article.

4. The control device according to claim 3, wherein the control code is further configured to cause the at least one processor to control the UAV to lower the article while making the UAV hover for the transferring of the article.

5. The control device according to claim 3, wherein the control code is further configured to cause the at least one processor to control the UAV to land for the transferring of the article.

6. The control device according to claim 1, wherein the UAV includes a propulsor configured to generate propulsion force, and
the control code is further configured to cause the at least one processor to perform drive control of the propulsor on the basis of the allowable noise level during the flight of the UAV.

7. The control device according to claim 6, wherein
the UAV further includes a fixed wing, and
the control code is further configured to cause the at least one processor to perform the drive control such that the driving of the propulsor is stopped and the UAV glides with the fixed wing.

8. The control device according to claim 6, wherein
the propulsor includes a plurality of rotary wings, and
the control code is further configured to cause the at least one processor to perform the drive control such that at least one of the plurality of rotary wings is stopped.

9. The control device according to claim 1, wherein
the UAV includes a propulsor configured to generate vertical propulsion force, and
the control code is further configured to cause the at least one processor to control a flight altitude of the UAV by controlling the propulsor on the basis of the allowable noise level during the flight of the UAV.

10. The control device according to claim 1, wherein
the UAV includes a rotary wing, an internal combustion engine, and a battery, and
the control code is further configured to cause the at least one processor to control the flight of the UAV by selecting, as a power source to drive the rotary wing, either one of power supplied by a driving of the internal combustion engine and power supplied from the battery, in a state where the driving of the internal combustion engine is stopped, in accordance with the allowable noise level during the flight of the UAV.

11. A control method performed by a control device configured to control an unmanned aerial vehicle (UAV), the control method including:
acquiring an allowable noise level identified on the basis of at least one of a time when the UAV is flying, an altitude at which the UAV is flying, an area where the UAV is flying, and weather in an airspace in which the UAV is flying; and
controlling flight of the UAV on the basis of the allowable noise level.

12. A non-transitory computer readable storage medium storing instructions that cause at least one processor, to:
acquire an allowable noise level of an unmanned aerial vehicle (UAV), the allowable noise level identified on the basis of at least one of a time when the UAV is flying, an altitude at which the UAV is flying, an area where the UAV is flying, and weather in an airspace in which the UAV is flying; and
control flight of the UAV on the basis of the allowable noise level.
